(19) United States
(12) Patent Application Publication
(10) Pub. No.: US 2006/0294228 A1
(43) Pub. Date: Dec. 28, 2006

(54) Systems and methods for preventing server overload

(75) Inventor: Mats Almstrom, Stockholm (SE)

Correspondence Address: BROWDY AND NEIMARK, P.L.L.C.;624 NINTH STREET, NW, SUITE 300, WASHINGTON, DC, 20001-5303, US

(73) Assignee: CINNOBER FINANCIAL TECHNOLOGY AB, Stockholm (SE)

(21) Appl. No.: 11/433,649

(22) Filed: May 15, 2006

Related U.S. Application Data
(60) Provisional application No. 60/681,167, filed on May 16, 2005.

(51) Int. Cl. G06F 15/173

(52) U.S. Cl. 709/224

(57) ABSTRACT

The present invention relates to methods, a system, computer readable mediums and computer program products for preventing overload of a network server (16a) of an electronic trading system (10). The inventive method comprises the steps of: monitoring (30) a resource utilization of the server (16a) by means of a number of parameters indicating the resource utilization; determining (32) whether the resources are over-utilized; and if it is determined that the resources are over-utilized, introducing (34) a throttling of the incoming transaction flow by delaying the incoming transactions a predetermined period of time.

### TECHNICAL AREA

The present invention relates to electronic trading systems for trading stocks, bonds, futures, options and other financial instruments as well as betting and e-gaming, and in particular to methods, systems, computer readable mediums and computer program products for such systems.

### BACKGROUND OF THE INVENTION

During the last decade, almost all the world's exchanges and marketplaces have introduced electronic trading systems. These systems either replace the traditional trading floors or are used as complements to them. Today a large number of exchanges throughout the world utilize electronic trading to trade stocks, bonds, futures, options and other financial instruments. These electronic exchanges generally includes three basic components, namely mainframe computers (host), communication servers, and the exchanges participants computers (client). The host constitutes, so to speak, the heart of the electronic trading system. The hosts operations includes, for example, order-matching, maintaining order books and positions or price information. Participants, e.g. traders, are capable of communicating with the host by means of high speed data lines, high speed communications servers and the Internet. Thus, the traders can participate in the market by means of the clients communicating with the host.

It is essential that such mission critical systems behave in a predictable way even when over-utilized and it is also of an uttermost importance that no interruptions of the transaction flow occur due to, for example, such over-loads.

In U.S. Pat. No. 5,878,224 an apparatus and method for preventing overload of a network server is disclosed. It is checked whether incoming transaction workload exceeds a threshold and if the threshold is exceeded, a transaction initiating rate of a client is reduced. In U.S. Pat. No. 6,839,767 a similar solution is presented. However, both these solutions are impaired with drawbacks. For example, the network communication of these systems may be significant since the transaction delay or reduction of transaction rate take place at the client side thereby requiring, from time to time, extensive communication between the server and the clients.

Thus, there is need of an improved system and a method for preventing overload of a network server of an electronic trading system.

### SUMMARY OF THE INVENTION

An object of the present invention is to provide an improved system and method for preventing overload of a network server of an electronic trading system.

These and other objects are achieved according to the present invention by providing a system, a method, a computer program, and a computer readable medium having the features defined in the independent claims. Preferred embodiments are defined in the dependent claims.

According to a first aspect of the present invention, there is provided a method for preventing overload of a network server of an electronic trading system. The method comprises the steps of: monitoring a resource utilization of the server by means of a number of parameters of the server indicating the resource usage; determining whether the resources are over utilized; and if it is determined that the resources are over-utilized, introducing a throttling of the incoming transaction flow by delaying the incoming transactions a predetermined period of time.

According to a second aspect of the present invention, there is provided a resource manager for preventing overload of a network server of an electronic trading system. The manager comprises a control means adapted to: monitor a resource utilization of the server by means of a number of parameters of the server indicating the resource usage; determine whether the resources are over utilized; and, if it is determined that the resources are over-utilized, introduce a throttling of the incoming transaction flow by delaying the incoming transactions a predetermined period of time.

According to a third aspect of the present invention, there is provided a method for assisting an operator of an electronic trading system to manage and supervise a resource manager in accordance with the second aspect, the method comprising the steps of: displaying at least one object on a display screen, the at least one object corresponding to the control means of the resource manager; and displaying parameters of the at least one object in response to operator actions by means of an input device.

According to a fourth aspect of the present invention, there is provided a computer apparatus for receiving commands related to managing and supervision of a resource manager in accordance with the second aspect, comprising: an interface for displaying at least one object on a display screen, the at least one object corresponding to the control means of the resource manager; and means for displaying parameters of the at least one object in response to operator actions by means of an input device.

According to a fifth aspect of the present invention, there is provided a computer program product, which when executed on a computer, performs steps in accordance with the method of the first aspect.

According to a further aspect of the present invention, there is provided a computer readable medium comprising instructions for bringing a computer to perform the method according to the first aspect.

Thus, the invention is based on the idea of monitoring a number of significant parameters of at least one server indicating the resource usage and performing the throttling of the incoming transaction flow at the server side by delaying the incoming transactions a predetermined and configurable period of time.

According to a preferred embodiment of the present invention all parameters used to monitor the resource usage are configurable.

As realized by the person skilled in the art, the methods of the present invention, as well as preferred embodiments thereof, are suitable to realize as a computer program or a computer readable medium.

These and other advantages with, and aspects of, the present invention will become apparent from the following detailed description and from the accompanying drawings.

### SHORT DESCRIPTION OF THE DRAWINGS

In the following description of an embodiment of the invention, reference will be made to the accompanying drawings of which:

FIG. 1 is a general view of an electronic trading system in which the present invention can be implemented;

FIG. 2 is a schematic block diagram of the resource manager in accordance with the present invention.

FIG. 3 shows schematically the general principles of the method for an electronic trading system according to the present invention.

### DETAILED DESCRIPTION OF THE INVENTION

In the following there will be discussed preferred embodiments of the methods and system for

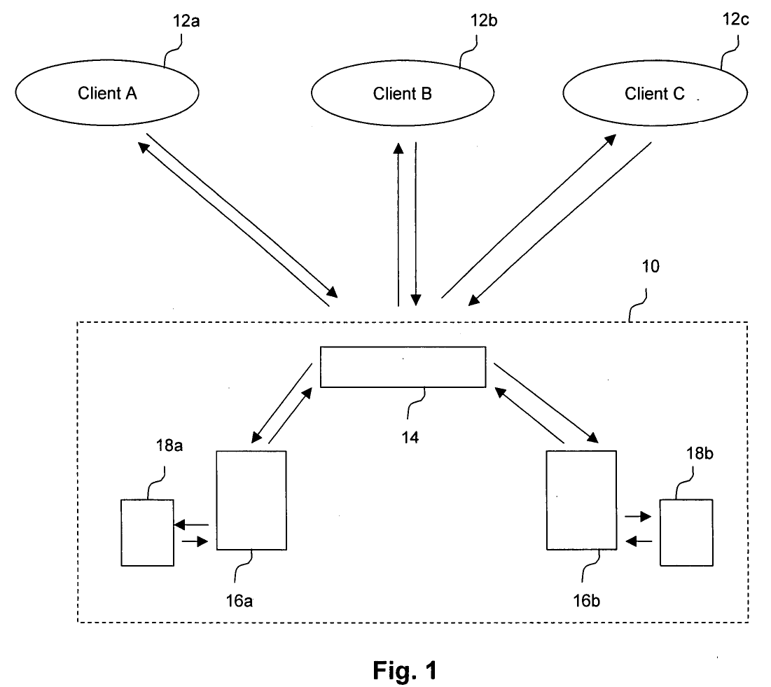

With reference first to FIG. 1, an electronic trading system in which the present invention can be implemented will be discussed. A number of clients, here indicated by client A 12a, client B 12b, and client C 12c, communicates with the trading or exchange system 10. Thus, traders can participate in the market by means of the clients 12a-12c communicating with the exchange system 10, i.e. the host. The clients 12a-12c may link to the system 10 via high speed data lines, high speed communication servers, or the Internet. High speed data lines establish direct connection between a client and the system. Connection can also be established between the client and the system by configuring high speed networks or communication servers at strategic access points in locations where traders physically are located. Internet is a third communication means enabling traders, using, for example, the clients 12a-12c, can communicate using, for example, high speed data lines connected to the Internet. Hence, trades are allowed to be located anywhere they can establish a connection to the Internet.

The system 10 comprises a gateway 14 arranged to receive incoming messages from the clients 12a-12c and distribute them to a server 16a acting as the primary node. In order to secure system availability, the exchange's system often uses two servers placed in two geographically different spots interconnected via a network. One of the servers is considered being the primary server and the other consequently as the secondary. The system will be operational with only one server acting as primary, but will then, of course, not be redundant. The primary server 16a accepts incoming messages from transferred from the gateway 14, stores them in a storage means 18a in a log file. This storage means 18a may of course be physically separated from the system 10 and the server 16a. Furthermore, the primary server 16a replicates the messages to a secondary node or server 16b, which, in turn, stores in a storage means 18b in a log file, which storage means may be of course be physically separated from the system 10 and the secondary server 16b. The two servers 16a, 16b perform the same business logic procedure based on the incoming message. This results in the two servers being synchronized and having the same application state. If the primary server 16a fails for some reason, the secondary server 16b is accordingly able to take over and take the role as primary node and accept incoming messages. On the other hand, if the secondary server fails for some reason, the primary server just continuous to operate.

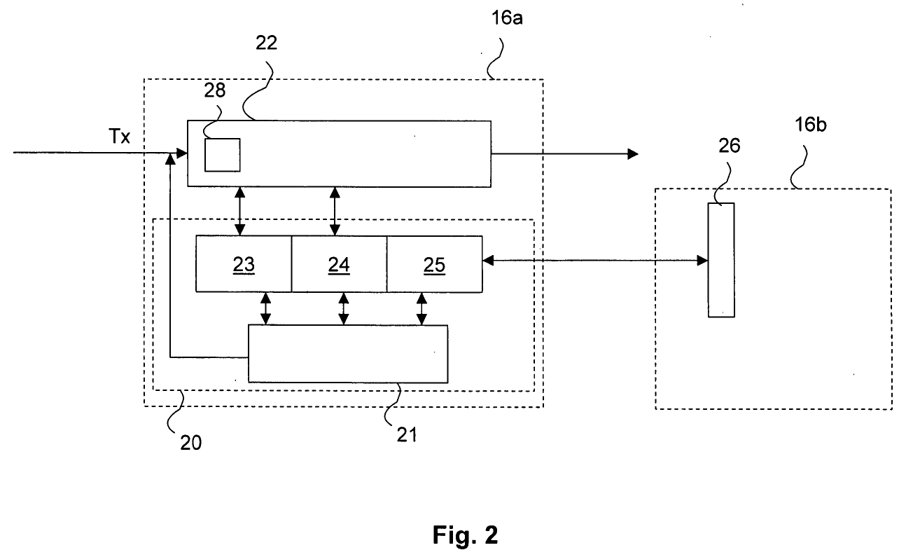

Turning now to FIG. 2, a resource manager for monitoring and handling of the resource utilization in accordance with the present invention will be discussed. The server 16a comprises a resource manager 20 and a processing unit 22 including, inter alia, business logic for processing incoming transactions. The resource manager 20 comprises, in turn, a control means 21, a memory monitoring means 23, a retransmission monitoring means 24, and standby request queue monitoring means 25.

The memory monitoring means 23 is adapted to poll the memory usage at a configurable interval, for example, 2 seconds. It is adapted to check the increase of memory usage in order to identify whether the usage increases over a configurable level (a default value may be 10%) or if the amount of free memory is less than a configurable level (a default value may be 20%) If any of these conditions indicate an over-utilization, the memory monitoring means 23 sends a overload indication signal to the control means 21.

The retransmission monitoring means 24 is adapted to supervise the amount of broadcast retransmissions. At a configurable interval, for example, 2 seconds the retransmission monitoring means 24 polls the number of retransmissions. If the number of retransmissions has increased over a configurable level (default value may be 10) since the last poll, the retransmission monitoring means 24 sends a overload indication signal to the control means 21.

The standby request queue monitoring means 25 is adapted to monitor the standby processing health of the server pair 16a, 16b. At a configurable interval, for example, 2 seconds the standby request queue monitoring means 25 polls the size of the incoming request queue 26 of the secondary server 16b. However, this, in fact, is performed by checking the acknowledge messages sent from the secondary server at receipt of each transaction message. Each acknowledge message contains information regarding the queue size of the standby queue 26. That is, for each acknowledge message received from the secondary server 16b, the request queue size is checked. Moreover, the queue size increase rate is also checked between consecutive messages. If the amount of requests waiting for processing is found to be above a predetermined level (a default value may be 200 requests) or if the queue size is growing too fast (a default level may be about 10 request per second), the standby request queue monitoring means 25 sends an overload indication signal to the control means 21. A further check is performed in order to assure that the standby queue is not stalled. This is executed by monitoring the queue of the primary server 16a for messages to be sent to the secondary server 16b. If the first element or message of this queue has been in line for transmission too long, typically about 5 seconds, it is determined that the standby queue has stalled. If the standby queue is found to be stalled, no time delay will be applied on the incoming transactions and the secondary server will be restarted or rebooted.

The control means 21 is adapted to read the state of the memory monitoring means 23, the retransmission monitoring means 24, and the standby request queue monitoring means 25 at a predetermined interval. In one embodiment, this predetermined interval is the shortest polling interval of the memory monitoring means 23, the retransmission monitoring means 24, and the standby request queue monitoring means 25. At an over-utilization indication, whether received from a monitoring means or obtained in the reading procedure, the control means applies a time delay on incoming transactions Tx and, thereby, the load of the system is decreased. The incoming transactions are buffered in an incoming standby queue 28. This time delay is configurable, a default value may be 40 milliseconds. However, if the over-utilization sustains at the next polling, the delay time can be increased by an increment factor (a default value may be 1.5). Preferably, a maximum value for the time delay is set, for example, 500 milliseconds.

When the over-utilization has ceased, i.e. when all monitoring means indicate normal usage, the time delay is removed. According to a preferred embodiment, the time delay is decreased by a decrement factor (a default value may be 0.42) for each poll occasion until the value is at or below the start value. If the decrement factor is set to 0.0, the throttling will be turned off as soon as the over-utilization has ceased.

Over-utilization of resources may occur at start of the servers as well as during normal operation. In order for the resource manager to work at warm start-up when transactions are read from the transaction log files, the same throttling delay can be applied to records read from the recovery and audit log file.

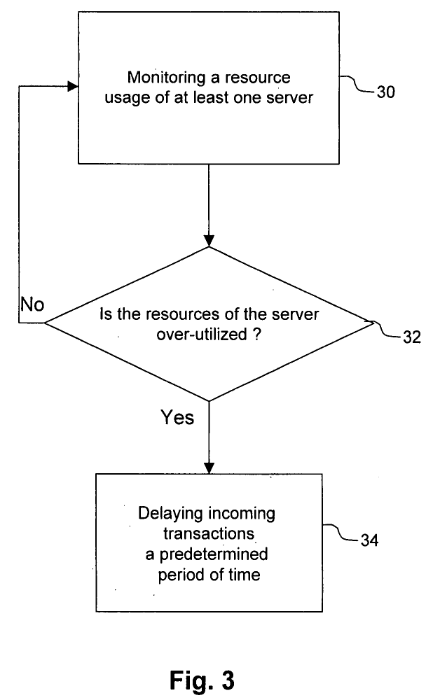

The general principles of the method for preventing over-usage of a server according to the present invention will now be discussed with reference to FIG. 3. First, at step 30, a resource utilization of the primary server 16a is monitored by means of the control means 21, the memory monitoring means 23, the retransmission monitoring means 24, and the standby request queue monitoring means 25 as described above. Then, at step 32, it is determined whether the resources of the server are over-utilized in accordance with the above-given description. Thereafter, at step 34, if it is determined that the resources are over-utilized, a throttling of the incoming transaction flow by delaying each of the incoming transactions a predetermined period of time is introduced by the control means 21 as described above.

An operator of a computer apparatus of a trading system, for example, the system shown in FIG. 1, is able to manage and control the resource manager 20 in real-time via a configuration GUI client. For example, the operator is able to monitor the different configurable parameters discussed above of the control means 21, the memory monitoring means 23, the retransmission monitoring means 24, and the standby request queue monitoring means 25. Thus, the operator is able to set properties in real-time for each monitoring means of the resource manager. Each monitoring means and the control means is represented on a display screen of the computer apparatus by symbols and the operator able to set properties in real-time for each monitoring means by using an input device, such as a pointing device, e.g. a mouse, or a keyboard.

Moreover, the operator is able to update the configurable parameters by double clicking on the symbol representing the specific monitoring means.

Although specific embodiments have been shown and described herein for purposes of illustration and exemplification, it is understood by those of ordinary skill in the art that the specific embodiments shown and described may be substituted for a wide variety of alternative and/or equivalent implementations without departing from the scope of the invention. Those of ordinary skill in the art will readily appreciate that the present invention could be implemented in a wide variety of embodiments, including hardware and software implementations, or combinations thereof. This application is intended to cover any adaptations or variations of the preferred embodiments discussed herein. Consequently, the present invention is defined by the wording of the appended claims and equivalents thereof.

1. A method for preventing overload of a network server (16a) of an electronic trading system (10), characterized by the steps of: monitoring (30) a resource utilization of said server (16a) by means of a number of parameters indicating said resource utilization; determining (32) whether said resources are over-utilized; and if it is determined that said resources are over-utilized, introducing (34) a throttling of the incoming transaction flow by delaying said incoming transactions predetermined period of time.

2. The method according to claim 1, wherein the step of monitoring comprises the step of:
monitoring the memory usage of said server (16a).

3. The method according to claim 2, wherein the step of monitoring the memory usage comprises the steps of: checking whether the increase of memory usage is above a predetermined level; checking whether the amount of free memory is less than a predetermined level; and if said memory usage is found to be above said predetermined level and/or said amount of free memory is found to be less than said predetermined level, introducing said throttling of the incoming transaction flow by delaying said incoming transaction said predetermined period of time.

4. The method according to claim 1, wherein the step of monitoring comprises the step of: monitoring the amount of broadcast retransmissions.

5. The method according to claim 4, wherein the step of monitoring the amount of broadcast retransmissions comprises the steps of: checking whether the number of retransmissions since a last check is above a predetermined level; and if said number of retransmissions since last check is found to be above said predetermined level, introducing said throttling of the incoming transaction flow by delaying said incoming transaction said predetermined period of time.

6. The method according to claim 1, wherein the step of monitoring comprises the step of: monitoring a standby queue (26) of a secondary server (16b) for incoming messages of said secondary server (16b).

7. The method according to claim 6, wherein the step of monitoring a standby queue comprises the steps of: checking whether the number of request in said queue waiting for processing is above a predetermined level; checking whether the increase rate of queue size is above a predetermined level; and if said number of request in said queue waiting for processing is above said predetermined level and/or said increase rate of queue size is above a predetermined level, introducing said throttling of the incoming transaction flow by delaying said incoming transaction said predetermined period of time.

8. A resource manager (20) for preventing overload of a network server (16a) of an electronic trading system (10), characterized by: control means (21) adapted to: monitor a resource utilization of said server (16a) by means of a number of parameters indicating said resource utilization; determine whether said resources are over-utilized; and if it is determined that said resources are over-utilized, introduce a throttling of the incoming transaction flow by delaying said incoming transactions a predetermined period of time.

9. The resource manger according to claim 8, further comprising a memory monitoring means (23) adapted to monitor the memory usage of said server (16a).

10. The resource manger according to claim 9, wherein said memory monitoring means (23) is adapted to: check whether the increase of memory usage is above a predetermined level; check whether the amount of free memory is less than a predetermined level; and
if said memory usage is found to be above said predetermined level and/or said amount of free memory is found to be less than said predetermined level, inform said control means of over-utilization of the resources.

11. The resource manger according to claim 8, further comprising retransmission monitoring means (24) adapted to monitor the amount of broadcast retransmissions.

12. The resource manger according to claim 8, wherein said retransmissions monitoring means (24) is adapted to: check whether the number of retransmissions since a last check is above a predetermined level; and if said number of retransmissions since last check is found to be above said predetermined level, inform said control means of over-utilization of the resources.

13. The resource manger according to claim 8, further comprising standby request queue monitoring means (25) adapted to monitor a standby queue (26) of a secondary server (16b) for incoming messages of said secondary server (16b).

14. The resource manger according to claim 8, wherein said standby request monitoring means (25) is adapted to check whether the number of request in said queue waiting for processing is above a predetermined level; check whether the increase rate of queue size is above a predetermined level; and if said number of request in said queue waiting for processing is above said predetermined level and/or said increase rate of queue size is above a predetermined level, inform said control means of over-utilization of the resources.

15. A method for assisting an operator of an electronic trading system to manage and supervise a resource manager (20) in accordance with claim 8, said method comprising the steps of: displaying at least one object on a display screen, said at least one object corresponding to a control means (21) of said resource manager (20); and displaying parameters of said at least one object in response to operator actions by means of an input device.

16. A computer apparatus for receiving command related to managing and supervision of a resource manager (20) in accordance with claim 8, comprising: an interface for displaying at least one object on a display screen, said at least one object corresponding to a control means (21) of said resource manager (20); and means for displaying parameters of said at least one object in response to operator actions by means of an input device.

17. A computer program product, which when executed on a computer, performs steps in accordance with claim 15.

18. A computer readable medium comprising instructions for bringing a computer to perform the method according to claim 15.

19. A computer program product, which when executed on a computer, performs steps in accordance with claim 1.

20. A computer readable medium comprising instructions for bringing a computer to perform the method according to claim 1.
